(19) United States
(12) Patent Application Publication
(10) Pub. No.: US 2016/0155589 A1
(43) Pub. Date: Jun. 2, 2016

(54) ISOLATOR FOR DC ELECTRICAL POWER SUPPLY SOURCE

(71) Applicant: COMMISSARIAT À L'ÉNERGIE ATOMIQUE ET AUX ÉNERGIES ALTERNATIVES, Paris (FR)

(72) Inventor: Christophe MANGEANT, Yenne (FR)

(73) Assignee: COMMISSARIAT A L'ENERGIE ATOMIQUE ET AUX ENERGIES ALTERNATIVES, Paris (FR)

(21) Appl. No.: 14/891,396

(22) PCT Filed: Apr. 24, 2014
(86) PCT No.: PCT/EP2014/058299

§ 371 Date: Nov. 16, 2015

(30) Foreign Application Priority Data
May 16, 2013 (FR) 1354410

(51) Int. Cl. H01H 39/00

(52) U.S. Cl. CPC H01H 39/006

(57) ABSTRACT

An isolator for DC electrical power supply source, including: a blade movable along a travel between a conduction position and an isolating position, driving of the blade along its travel breaking a first electrical conductor, configured to conduct current from a DC supply source, into two mutually electrically insulated portions; a pressurized gas source selectively driving the blade along its travel; a pyrotechnic element including a detonator triggered by external command and an explosive whose explosion is initiated by the detonator, explosion of the explosive inducing the driving of the blade by the gas source.

The invention concerns DC electrical power supply sources, such as photovoltaic installations or power batteries, in which the voltage frequently exceeds 50 Volts with a current greater than several hundred milliamperes.

Such DC electrical power supply sources most often include multiple generators of the same type connected in series, in order to have satisfactory voltage levels for the intended application. Thus, photovoltaic electricity generators installed in a domestic or corporate context generally have multiple photovoltaic panels connected in series. Such photovoltaic panels are frequently arranged on the roof of a building and generate a current returned to the public electrical network via an inverter. By connecting photovoltaic panels in series, a DC voltage is generated of a sufficiently high level to allow optimum conversion by the inverter. Multiple branches may be connected in parallel on the inverter each including multiple photovoltaic panels connected in series. With the need to increase production from renewable energies, the power from photovoltaic installations is constantly growing. The voltage and current levels generated may therefore be relatively high.

During maintenance operations on the network or during safety interventions in the building, the power supply of the building's electrical network is generally provided by switching a circuit breaker on the main electrical box. Furthermore, since the inverter is generally powered by the electrical network, its operation is automatically interrupted upon switching the circuit breaker. Thus, even if the photovoltaic panels continue to be illuminated, the current return onto the electrical network is interrupted. Thus, there is no fear of electric shock on the electrical network between the main box and the inverter.

However, in particular when working near a photovoltaic installation, there remains a risk that water, e.g. discharged by fire crews during a fire, may conduct electricity from the photovoltaic panels up to a response or maintenance team, e.g. if some protective sheaths are degraded. A risk also remains of direct contact with a degraded live conductor. If the photovoltaic panels are illuminated at the time of intervention, they may continue to generate a voltage of up to several tens or several hundreds of volts. There then follows a risk of electric shock for people nearby. Consequently, in the presence of such DC voltage generators in a fire zone, rescue teams are sometimes led to stop their intervention and wait for the end of the fire. The extent of the damage may then be severely augmented, particularly in an industrial context. In addition, personnel clearing the site after the fire are also faced with a risk of electric shock.

Photovoltaic panels are intrinsically risk factors for starting a fire. Indeed, current/voltage generation occurs inside the photovoltaic panel itself. Internal faults in the panels (defective welds, broken cell or electrical insulation fault) may cause internal electrical arcing causing fires to start. Similarly, because of the energy stored in electrochemical batteries, the risk of a fire starting is increased by potential uncontrolled chemical reactions inside these batteries.

There is no known solution enabling a response team to eliminate the risk of electric shock reliably, instantaneously and from a safe area, purely mechanically and not involving a semiconductor element in the device as close as possible to the photovoltaic panels.

Document US2010/0218659 discloses an isolator for electrical connection cables to a power source, comprising a movable blade.

Document US2004/0112239 discloses a pyrotechnic isolator provided with a movable blade along a travel between a conduction position and an isolating position.

Document US6556119 discloses an isolator for electrical connection cables in an automotive context and comprising a movable isolating element.

The invention aims to address one or more of these drawbacks. The invention thus relates to a DC electrical power supply system, as defined in the appended claims.

The invention also relates to an isolator for DC electrical power supply source, as defined in the appended claims.

Other features and advantages of the invention will emerge clearly from the description which is given below, as a guide and in no way restrictive, with reference to the appended drawings in which:

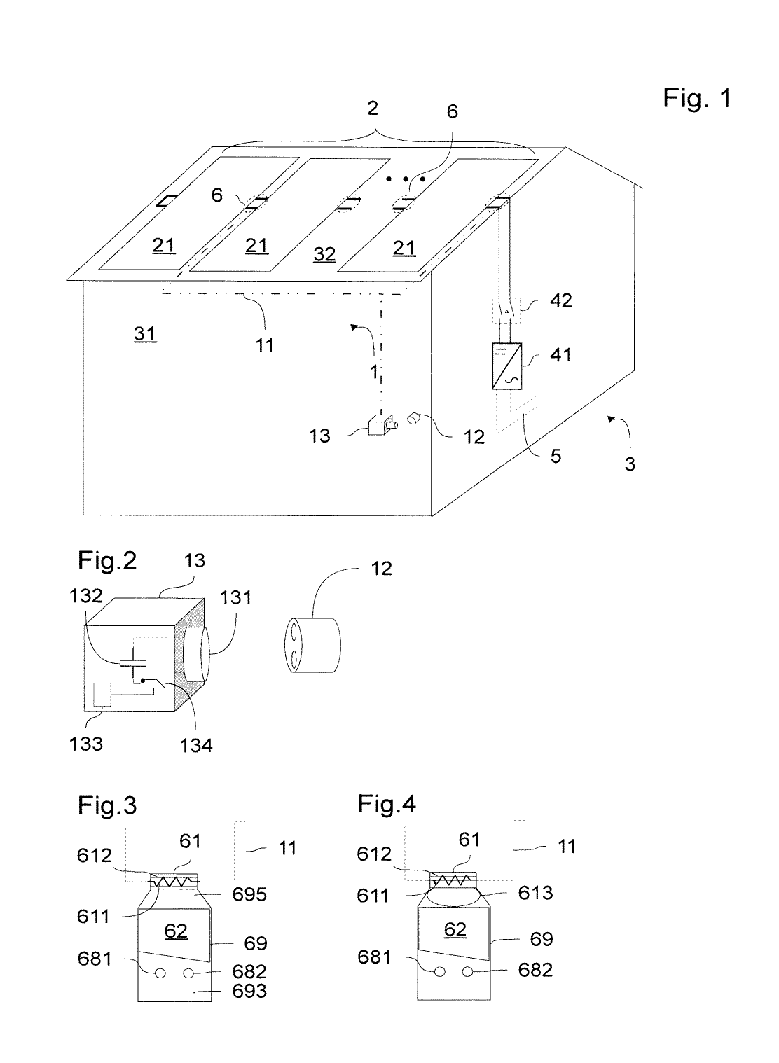

FIG. 1 is a schematic perspective view of an example of implementation of the invention in a building;

FIG. 2 illustrates an example of a detonator control with a connector of an associated isolator;

FIG. 3 is a schematic cross-sectional view of one embodiment of an isolator.

FIG. 4 is a schematic cross-sectional view of a variant of the isolator in FIG. 3;

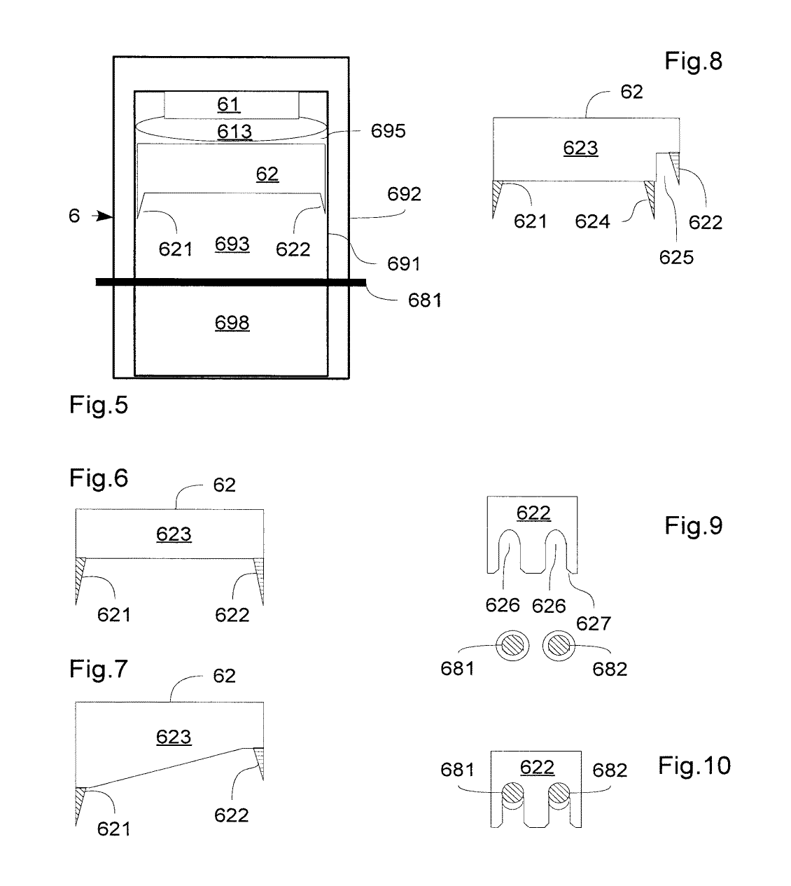

FIG. 5 is a schematic longitudinal section view of another variant of the isolator in FIG. 3;

FIG. 6 is a schematic longitudinal section view of a first variant of the isolator blade;

FIG. 7 is a schematic longitudinal section view of a second variant of the isolator blade;

FIG. 8 is a schematic longitudinal section view of a third variant of the isolator blade;

FIGS. 9 and 10 illustrate the respective positions of a first variant of short-circuit conductor and power supply cables, in different configurations;

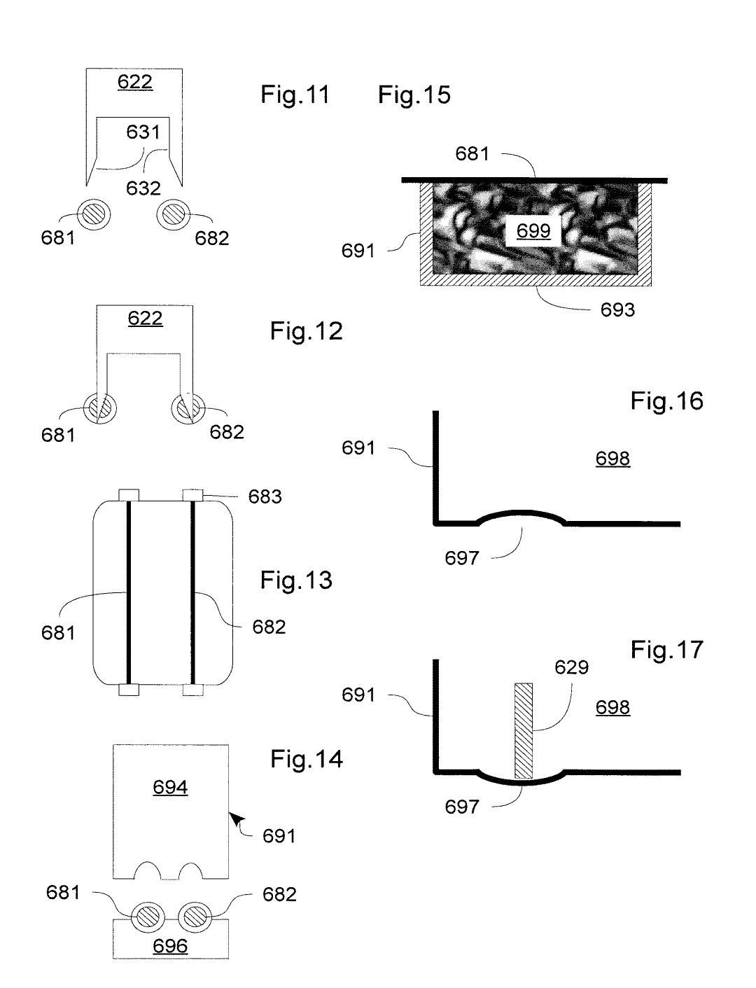

FIGS. 11 and 12 illustrate the respective positions of a second variant of short-circuit conductor and power supply cables, in different configurations;

FIG. 13 schematically illustrates a first configuration of power supply cables in an isolator;

FIG. 14 schematically illustrates a second configuration of power supply cables in an isolator;

FIG. 15 schematically illustrates a clearance space for the isolator blade, filled with foam;

FIG. 16 schematically illustrates a bottom wall of an isolator housing before use;

FIG. 17 schematically illustrates the bottom wall of the isolator housing after use;

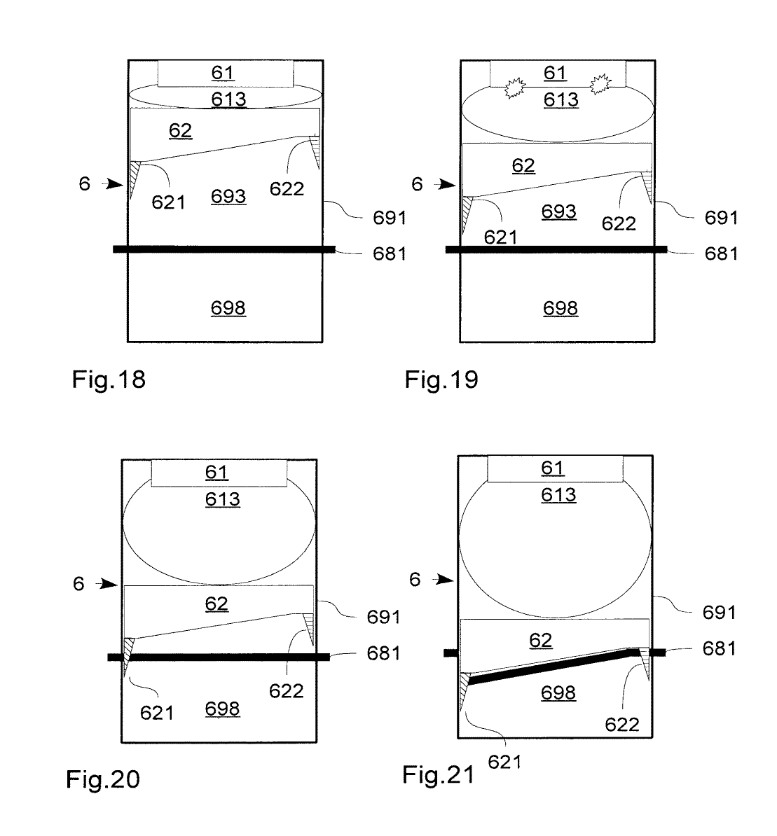

FIGS. 18 through 21 illustrate an isolator provided with the blade in FIG. 7 for different positions of this blade.

The invention notably provides for the use of an isolator provided with a blade driven by pressurized gas following the explosion of an explosive belonging to a pyrotechnic element. In its travel, the blade mechanically breaks an electrical conductor of the current from the DC power supply source.

An isolator is thus obtained that almost instantaneously cuts off conduction, based on a reliable mechanical break. A mechanical break is further able to reassure the response staff, accustomed to ensuring the protection of a site against electric shock by mechanically cutting power supply cables. In addition, the pyrotechnic elements are components capable of being produced on a large scale at reduced cost and whereof the operation is widely proven and mastered. Furthermore, the use of such an isolator does not imply maintaining a standby electrical power supply and requires only low external energy.

FIG. 1 is a schematic perspective view of a building 3 in which an example of a DC electrical power supply system 1 according to one embodiment of the invention is implemented.

The system 1 comprises a DC electrical power supply source 2. The source 2 is connected to an inverter 41 via power supply cables and via a circuit breaker 42 (provided with an emergency shutdown actuator and typically arranged inside the building 3 close the inverter 41).

In this case, the source 2 includes multiple DC power supply elements connected in series. The DC power supply electrical elements here are photovoltaic panels 21 electrically connected in series, and arranged on the roof 32 of the building 3. The photovoltaic panels 21 generate a DC current and voltage when they are exposed to the sun's rays.

The photovoltaic panels 21 are connected to the (+) and (−) DC voltage inputs of the inverter 41. An AC voltage output of the inverter 41 is connected to an electrical network 5, e.g. a public electrical network. The inverter 41 in a way known per se performs a DC/AC conversion and transformation of the voltage level generated by the photovoltaic modules to a voltage level compatible with the electrical network 5. The electrical network 5 includes its own electrical protection housing including a main circuit breaker, in a way known per se. The inverter 41 may also include a switch for isolating it from the electrical network 5.

Each photovoltaic panel 21 generates, for example, a maximum voltage of less than 50 V DC, preferably less than 45 V DC when it is exposed to the sun's rays. Such voltage levels cannot induce serious electric shock. The combination in series of multiple photovoltaic panels 21 is used to generate a voltage of several hundred volts, which may prove appropriate for its conversion into an AC voltage and returning the electrical current generated onto the electrical network 5.

Isolators 6 are positioned between the photovoltaic panels 21 on the one hand and between a photovoltaic panel 21 and the inverter 41 on the other. When the isolators 6 are opened, the voltage liable to be present at one point of the circuit connecting the photovoltaic panels is therefore reduced. The system 1 further includes an electrical network including cables 11 connecting the isolators 6 to a control connector 12. The cables 11 will be dimensioned in accordance with the standards for safety devices and may be routed in an optimized way with regard to the risk of fire spreading. The control connector 12 is permanently attached onto the building 3, e.g. on an external wall 31 of the building or any other easily accessible place visible to the response services. The system 1 further includes a control 13, e.g. in the form of a portable control.

An isolator 6 according to the invention comprises a blade movable along a travel between a conduction position (closure of the isolator 6) and an isolating position (opening of the isolator 6). The driving of the blade on its travel breaks a conductor conducting the current from the DC power supply source 2, this conductor is then separated into two portions electrically isolated from each other. A pressurized gas source is used for selectively driving the blade along its travel, when it is intended to open the isolator 6. For this purpose, the isolator 6 includes a pyrotechnic element provided with a detonator triggered by external control and an explosive whereof the explosion is initiated by the detonator. The explosion induces the driving of the blade by the pressurized gas source. Different variants of isolators 6 are illustrated and detailed later.

FIG. 2 schematically illustrates an example of detonator control 13. The control 13 comprises a connector 131 whereof the form factor is complementary to the connector 12. Thus, the connector 131 may be coupled to the connector 12, the connector 12 thus preventing an inappropriate connection of the cables 11 to the electrical network. Malicious actuation of the isolator 6 is thus avoided. The control 13 includes an electrical energy storage device 132, e.g. an electrochemical battery or a capacitor. The energy storage device 132 is selectively connected to the connector 131 via a switch 134. The switch 134 is of the normally open type, its closure being controlled via an interface 133 intended to be operated by the user of the control 13, when they wish to control the isolator 6. The storage device 132 is preferably rechargeable by means of a control interface 13, e.g. for being kept on a charging base inside a response vehicle.

Advantageously, the control 13 may comprise an indicator light, indicating whether all the isolators 6 controlled by the cable network 11 are open. By determining, for example, that thermistors in the detonators have been broken, such an indicator enables the user that has connected their control 13 to the cable network 11 to verify that all the isolators 6 are open. The indicator also allows the user to determine whether there is a risk of electric shock by the DC power source 2. Compared with automatic isolators, such an isolator 6 reassures the response teams since they retain control of the electrical isolation.

In the variants illustrated and described in detail below, the gas produced by the explosion drives the movable blade. The pyrotechnic element of the isolator 6 is therefore used to produce the gas for driving the blade. However, it is also conceivable to drive the movable blade by means of a pressurized gas stored in a reservoir, the explosion then being used to open a valve between this reservoir and the movable blade.

FIG. 3 is a schematic cross-sectional view of a first variant of an isolator 6. Such an isolator 6 may occupy a space limited to a few tens of cubic centimeters. The isolator 6 comprises a pyrotechnic element 61. The pyrotechnic element 61 includes a thermistor 611 and an explosive 612 in which the thermistor 611 is embedded. The thermistor 611 is connected to the connector 12 via cables 11 of the control network. The pyrotechnic element 61 is attached to a hermetically sealed enclosure 69 of the isolator 6. A blade 62 is movably mounted in the enclosure 69. The enclosure 69 comprises an expansion chamber 695 arranged between the explosive 612 and the blade 62. First and second electrical conductors 681 and 682 pass through the enclosure 69. The blade 62 is movably mounted in the enclosure 69 along a travel. This travel comprises an initial conduction or closure position, in which the blade 62 is spaced apart from the conductors 681 and 682 (position illustrated in FIG. 3). The travel also comprises a terminal isolating or opening position, the driving of the blade 62 along this travel inducing the breaking of the electrical conductors 681 and 682 by mechanical interference with this blade 62. The electrical conductors 681 and 682 pass through a cutting chamber 693 of the enclosure 69, the blade 62 here being interposed between the cutting chamber and the expansion chamber.

To open the isolator 6, an electrical pulse of sufficient duration and power (e.g. a few amperes for a few milliseconds) is applied by the control 13 on the thermistor 611, via the cables 11. The thermistor 611 forms a detonator for the explosive 612 by heating it to cause the explosion. The gases produced by the explosion spread into the expansion chamber 695 and then drive the blade 62 along its travel. Since a high pressure may be obtained in the expansion chamber 695, the blade 62 cuts the conductors 681 and 682, in order to ensure the breaking of each of these conductors into two parts isolated from each other. Thus any possible current passing through the electrical power supply 2 is cut off. A sufficient quantity of explosive 612 will be used in order to ensure the cutting of the conductors 681 and 682 capable of being used.

The blade 62 is slidingly mounted in the enclosure 69. The fit between the blade 62 and the enclosure 69 is appropriately defined to allow both the sliding of the blade 62 along its travel, and to ensure that the expansion of the gases produced by the explosion drive the blade 62 rather than interfering between the enclosure 69 and the periphery of this blade 62.

The blade 62 is advantageously mechanically held in the closure position of the isolator 6, e.g. by means of flexible pins protruding inside the enclosure 69. The blade 62 will clear these flexible pins to be driven along its travel only when sufficient stress is exerted on the blade 62 by the gases under pressure due to the explosion.

FIG. 4 is a schematic cross-sectional view of a second variant of an isolator 6. The isolator 6 according to this variant follows the structure of the isolator 6 of the first variant. In this second variant, the isolator 6 comprises an envelope or membrane 613 arranged in the expansion chamber 695, between the explosive 612 and the blade 62. Such an envelope 613 is, for example, made of a textile such as those used for producing safety airbags. After the explosion of the explosive 612, the pressurized gas produced flows into the envelope 613, the filling of the envelope 613 driving the blade 62 along its travel. The use of an envelope 613 ensures a driving of the blade 62 by the gases generated by the explosion without being troubled by the seal between the blade 62 and the enclosure 69.

Advantageously, the explosive 612 is configured for spontaneously exploding during a prolonged maintenance of the isolator 6 at a temperature at least equal to 200°. Thus, the isolators 6 will be automatically actuated to make the building 3 safe during a fire.

FIG. 5 is a schematic longitudinal section view of one embodiment of the isolator 6 in FIG. 3. The blade 62 here is slidingly mounted in a guide 691. The enclosure 69 includes a sealed housing 692 including the guide 691 and protecting the components placed inside from dust, moisture, or chemical or mechanical attack. The sealed housing 692 may be made of the same material as the materials of the normal junction boxes of photovoltaic panels, e.g. high density polyethylene (HDPE). The housing 692 also helps ensure the safety of persons against the explosion of the explosive 612 and against movements of the blade 62. Such a configuration enables the isolator to be handled by people with no training in the handling of explosives, in spite of the presence of the pyrotechnic element 62. The cutting chamber 693 extends under the conductors 681 and 682 via a clearance space 698 intended to receive the blade 62 at the end of travel. A ratchet mechanism may be provided in the clearance space 698 for holding the blade 62 once in its isolating position, and thereby ensuring the irreversibility of the isolation.

The blade 62 includes a cutting element 621. The element 621 advantageously has a sharp form for facilitating the breaking of the conductors 681 and 682. The cutting element 621 is advantageously made of electrical insulating material, e.g. an insulating ceramic. The cutting element 621 is configured for being interposed between the isolated portions of the conductors 681 and 682 in the isolating position of the blade 62. The cutting element 621 thus ensures an opening without any arcing between the isolated portions of each of the conductors 681 and 682.

The isolator 6 further includes a conductive element 622 rigidly connected to the blade 62. The conductive element 622 is configured for interfering with the conductors 681 and 682 on the blade 62 travel between the conduction and isolating positions. In the isolating position of the blade 62, the conductive element 622 electrically connects an isolated portion of the conductor 681 to an isolated portion of the conductor 682. Thus:
one isolated portion of the conductor 681 is electrically isolated from one isolated portion of the conductor 682 on an interface of the isolator 6 e.g. connected to the inverter 41;
another isolated portion of the conductor 681 is electrically connected to another isolated portion of the conductor 682 on an interface of the isolator 6 e.g. connected to a photovoltaic panel 21.

FIG. 6 is a schematic longitudinal section view of a first variant of a blade 62. The blade 62 includes a wall 623 forming a piston and a support. The blade 62 further includes an electrically insulating cutting element 621 attached onto the lower face of the piston 623. The blade 62 further includes an electrically conductive element 622 attached onto the lower face of the piston 623. The cutting element 621 and the conductive element 622 are attached onto opposite sides of the piston 623. The piston 623 here comprises a flat lower face and the cutting element 621 and the conductive element 622 are arranged so as to protrude the same distance from this lower face.

FIG. 7 is a schematic longitudinal section view of a second variant of a blade 62. The lower face of the piston 623 is inclined, so that the lower end of the cutting element 621 is arranged under the end of the conductive element 622. Thus it is ensured that the conductors 681 and 682 are broken by the cutting element 621 before a conduction between these conductors 681 and 682 by the conductive element 622. In addition, this variant increases the distance between the two isolated portions of the same conductor in the isolating position. Thus the risk of an electric arc forming between these isolated portions is further reduced.

FIG. 8 is a schematic longitudinal section view of a third variant of a blade 62. The lower face of the piston 623 comprises a flat part. Insulating cutting elements 621 and 624 are attached to each end of this flat part. The piston 623 comprises an offset 625 at one end. The conductive element 622 is attached at this offset 625. The lower end of the cutting elements 621 and 624 is thus arranged under the lower end of the conductive element 622. The conductors 681 and 682 are thus broken by the cutting elements 621 and 624 before a conduction between these conductors 681 and 682 by the conductive element 622. In addition, because of the presence of two cutting elements at different locations along the conductors 681 and 682, a complete section of the conductors 681 and 682 is cut and driven by the blade 62, improving the reliability of isolation.

FIGS. 9 and 10 schematically illustrate in a front view a first variant of a conductive element 622, in a conduction position of the isolator 6 and in an isolating position respectively. The conductive element 622 includes a metal plate in which two grooves 626 (which are optionally sharp-edged) are arranged. In the conduction position of the isolator 6 illustrated in FIG. 9, the grooves 626 are positioned in line with the respective conductors. The metal plate advantageously comprises chamfers 627 at the entrance of the grooves 626 for facilitating the entry of the conductors 681 and 682 into the grooves 626 during the travel of the blade 62. In the isolating position illustrated in FIG. 10, the conductors 681 and 682 are positioned in the grooves 626. The conductive element 622 passes through the insulating sheaths of the conductors 681 and 682 and is in contact with the conductive part of these conductors 681 and 682. A short circuit is thus formed between these conductors 681 and 682.

The width of the grooves 626 is advantageously less than the diameter of the conductive part of the conductors 681 and 682, so that in the isolating position, the conductive element 622 is mechanically coupled to the conductors 681 and 682 by plastic deformation of their conductive part.

FIGS. 11 and 12 schematically illustrate in a front view a second variant of a conductive element 622, in a conduction position of the isolator 6 and in an isolating position respectively. The conductive element 622 includes two needles 631 and 632 connected by a support. The needles 631 and 632 extend in a vertical direction. In the conduction position of the isolator 6 illustrated in FIG. 11, the needles 631 and 632 are positioned in line with the conductors 681 and 682 respectively. In the isolating position illustrated in FIG. 12, the needles 631 and 632 pass through the insulating sheaths of the conductors 681 and 682 and are driven into the conductive part of these conductors 681 and 682. A short circuit is thus formed between these conductors 681 and 682. The conductive element 622 is thus mechanically coupled to the conductors 681 and 682 by plastic deformation of their conductive part. Each isolator 6 is positioned so that the conductive element 622 electrically connects the parts of the conductors 681 and 682 connected to a photovoltaic panel 21.

FIG. 13 schematically illustrates a first configuration of power supply cables in an isolator 6. The conductors 681 and 682 are permanently attached inside the enclosure 69 and are therefore an integral part of the isolator 6. The conductors 681 and 682 are attached to the housing 692 to prevent their external part from being displaced during isolation. Each conductor 681, 682 has its ends connected to electrical power connectors 683. These connectors 683 are, for example, in the form of male or female plugs, accessible from outside the enclosure 69 for connection to the inverter 41 or to the photovoltaic panels 21. These connectors 683 may have a standardized form factor such as the multi-contact No. 3 connector system (MC3) or the multi-contact connector system No. 4 (MC4). Such a configuration reduces the risk of accidents by incorrect operation, since the user does not have access to the areas of the conductors 681 and 682 undergoing breakage. The breaking of the conductors 681 and 682 is also fully controlled, since the conductors 681 and 682 are designed and assembled by the manufacturer of the isolator 6 itself. The conductors 681 and 682 may have smaller sections than the cutting element 621 or the conductive element 622, e.g. by locally reducing the thickness of their sheath.

In the second configuration of FIG. 14, the conductors 681 and 682 are connecting conductors between photovoltaic panels 21, or between a photovoltaic panel 21 and the inverter 41. The isolator 6 may then be added onto an existing installation or onto conductors 681 and 682 connecting two photovoltaic panels in series as one piece. For this purpose, the guide 691 may be produced in two interlocking parts 694 and 696. The meeting of the parts 694 and 696 forms openings intended to be traversed by the conductors 681 and 682. A seal is advantageously ensured at the openings for the passage of the conductors 681 and 682. The conductors 681 and 682 are advantageously sufficiently tight in the openings of the interlocking parts 694 and 696, thus preventing the external part of these conductors 681 and 682 from being displaced during isolation. One such variant facilitates mounting on a pre-existing installation but requires to be handled by a qualified person for taking into account any possible displacement of the blades in case of unwanted triggering.

In the variant illustrated in FIG. 15, a foam 699 fills the clearance space of the guide 691 positioned under the conductors 681 and 682. The foam 699 may be very porous and have a very reduced density so as not to unduly slow down the travel of the blade 62. According to this variant, the movement of the blade 62 is dampened down after the conductors 681 and 682 are broken. This variant may further be used to reduce the quantity of air and the risk of condensation inside the guide 691, and thus to reduce the risks of oxidation and deterioration in the life of the isolator 6. The interior of the guide 691 may also be placed under vacuum, in order to facilitate the displacement of the blade 62 and reduce the risk of condensation in the guide 691.

FIG. 16 schematically illustrates a cross-sectional view of a guide 691 at its clearance space 698. The bottom of the guide 691 forms a stop for interrupting the travel of a non-blunt part 629 rigidly connected to the blade 62. The bottom of the guide 691 here presents a raised feature 697 protruding inside the clearance space 698. This raised feature 697 is arranged in line with the cutting element 621. Thus, at the end of travel, the part 629 hits the raised feature 697 to push back the protruding raised feature 697 outside the guide 691, in the configuration illustrated in FIG. 17. The raised feature 697 is arranged so that it is visible from outside the isolator 6, so that an operator may visually check whether or not the isolator 6 has been operated. The raised feature 697 thus forms a visual indicator of the conduction position or the isolating position of the isolator 6. The bottom of the guide 691 is advantageously made of sheet metal in order to offer a satisfactory mechanical resistance during the deformation of the raised feature 697.

FIGS. 18 through 21 illustrate various positions of a blade 62 according to the variant in FIG. 7, during the passage from a conduction position to an isolating position in the isolator 6.

In the position in FIG. 18, the blade 62 is in the conduction position. The blade 62 is thus kept near the pyrotechnic element 61.

In FIG. 19, an explosion is triggered by the pyrotechnic element 61, so that the membrane 613 inflates and begins to push the blade 62 into the guide 691. The blade 62 then approaches the conductors 681 and 682.

In FIG. 20, the membrane 613 continues to inflate, and the blade 62 is driven farther along its travel in the guide 691. The cutting element 621 then interferes with the conductors 681 and 682 to break each of them into two isolated parts. The isolating position of the blade 62 is thus reached.

In FIG. 21, the membrane 613 continues to inflate, and the blade 62 is driven up to the end of its travel. In this position, the conductive element 622 electrically connects the conductors 681 and 682. In this position, the blade 62 support drives the portions of the conductors 681 and 682 housed inside the guide 691, so that the cutting element 621 separates each of the conductors 681 and 682 into two isolated and distant portions.

One example of dimensioning of the pyrotechnic element 61 will be described in detail. It is assumed that the conductors 681 and 682 use a conductive copper section. The energy-to-break for copper is typically 10 MJ/m². The energy delivered by a common example of explosive 612 for automobile airbags is 5 MJ/kg.

Breaking a copper wire with a cross-section of 10 mm² therefore requires approximately the energy delivered by 20 mg of explosive. Thus, in the previous examples, two conductors 681 and 682 must be broken by the explosion, and interfere with the blade 62 in two locations, with the cutting element 621 and with the conductive element 622 respectively. Accordingly, it is assumed that the blade 62 must achieve 4 breaks. Accordingly, a minimum quantity of 80 mg of explosive must be used. As a large part of the energy of detonation is dissipated in the form of heat and movement of mechanical parts (inflation of the membrane 613 and displacement of the blade 62), for example, it may be estimated that between 20% and 50% of the energy of detonation is converted into mechanical energy of the blade 62. A mass of explosive 612 of 160 mg to 400 mg may thus be used on the basis of this performance. The mass of explosive 612 may, of course, be greater, to take a safety factor into account. These calculations may, of course, be corrected in the presence of a sheath surrounding the conductive sections of the conductors 681 and 682 or according to more accurate knowledge of the proposed pyrotechnic elements.

In the examples previously described, the pressurized gas driving the blade of the electrical conductor is produced by the explosion of the explosive present in the pyrotechnic element. However, it is also conceivable that the pressurized gas driving the blade of the electrical conductor may be stored in a cylinder separated from the blade by a valve, the explosion of said explosive then inducing the opening of the valve to drive the blade 62.

In the examples previously described, the blade 62 slides along a travel. However, other types of isolating travel may, of course, be provided, e.g. by rotating the blade 62.

The DC power supply sources 2 based on photovoltaic panels typically have peak powers of the order of 3 kWp for private individuals, between 100 and 300 kWp for industrial installations or agricultural buildings, or between 1 and 10 MWp for photovoltaic power plants.

In the examples previously described, the DC power supply source 2 is formed of photovoltaic panels. However, the invention is also usable for any other DC power supply source capable of inducing an electric shock, such as a battery of electrochemical power storage cells.

In the examples previously described, the isolator simultaneously cuts two different conductors. However, it is conceivable to produce an isolator for cutting a single phase conductor. A separate isolator may then be used for each phase.

In the examples previously described, the isolators 6 are arranged on the series electrical connections between the photovoltaic panels. However, for a high-voltage photovoltaic panel, isolators may be arranged on series connections right inside the panel, so that the voltage level capable of being applied is sufficiently low to prevent electric shock.

A single isolator may be provided in the electrical installation, between the DC voltage source and the inverter.

1-13. (canceled)

14. A DC electrical power supply system, comprising:
a DC electrical power supply source;
a first electrical conductor for conducting current from the DC power supply source;
a second electrical conductor for conducting the current from the DC power supply source;
an isolator, including:
a blade movable along a travel between a conduction position and an isolating position, driving of the blade along its travel breaking the first electrical conductor into two portions electrically isolated from each other, the driving of the blade along its travel breaking the second electrical conductor into two electrically isolated portions;
a pressurized gas source selectively driving the blade along its travel;
a pyrotechnic element including a detonator triggered by external control and an explosive whereof explosion is initiated by the detonator, the explosion of the explosive inducing the driving of the blade by the gas source;
a conductive element rigidly connected to the blade in its travel and electrically connecting an isolated portion of the first conductor to an isolated portion of the second conductor in the isolating position of the blade.

15. The electrical power supply system as claimed in claim 14, further comprising:
an electrical circuit connected to the detonator;
a first connector remote from the pyrotechnic element and connected to the electrical circuit;
a detonator control including:
a second connector having a form factor complementary to the first connector;
a source of electrical energy connected to the second connector.

16. The electrical power supply system as claimed in claim 14, further comprising an electrical distribution network connected to the electrical power supply source via first and second electrical conductors, the conductive element electrically connecting the isolated portions of the first and second conductors connected to the electrical distribution network.

17. The electrical power supply system as claimed in claim 14, wherein the electrical power supply source includes at least two electricity generating elements connected in series via the first and second conductors.

18. An isolator for DC electrical power supply source, comprising:
a blade movable along a travel between a conduction position and an isolating position, driving of the blade along its travel breaking a first electrical conductor, for conducting current from a DC power supply source, into two portions electrically isolated from each other, the driving of the blade along its travel breaking a second electrical conductor, for conducting a DC power supply source, into two electrically isolated portions;
a pressurized gas source selectively driving the blade along its travel;
a pyrotechnic element including a detonator triggered by external control and an explosive whereof explosion is initiated by the detonator, the explosion of the explosive inducing the driving of the blade by the gas source;
a conductive element rigidly connected to the blade in its travel and electrically connecting an isolated portion of the first conductor to an isolated portion of the second electrical conductor in the isolating position of the blade.

19. The isolator as claimed in claim 18, wherein the explosion of the explosive produces the pressurized gas for driving the blade.

20. The isolator as claimed in claim 19, further comprising an envelope into which the pressurized gas produced by the explosion of the explosive flows, filling of the envelope driving the blade.

21. The isolator as claimed in claim 18, wherein the explosive is configured for spontaneously exploding during a prolonged maintenance at a temperature at least equal to 200°.

22. The isolator as claimed in claim 18, wherein the blade includes an insulating material configured to be interposed between the two isolated portions when the blade is in the isolating position.

23. The isolator as claimed in claim 18, wherein the conductor electrically connects the isolated portions by mechanical coupling by plastic deformation of the isolated portions.

24. The isolator as claimed in claim 18, further comprising first and second electrical power connectors respectively connected to first and second ends of the first electrical conductor.

25. The isolator as claimed in claim 18, further comprising a housing in which the first electrical conductor, the blade, and the pyrotechnic element are housed, the isolator comprising a visual indicator indicating outside the housing whether the blade is arranged in the conduction position or in the isolating position.

26. The isolator as claimed in claim 18, wherein the blade drives in its travel one end of an isolated portion of the first conductor to maintain the end away from the other isolated portion of the first conductor in the isolating position of the blade.
